(19) United States
(12) Patent Application Publication
(10) Pub. No.: US 2017/0088750 A1
(43) Pub. Date: Mar. 30, 2017

(54) HIGH TEMPERATURE MOLDABLE PRESSURE SENSITIVE ADHESIVE SYSTEM

(71) Applicant: Zephyros, Inc., Romeo, MI (US)

(72) Inventor: Kendall Bush, Macomb, MI (US)

(21) Appl. No.: 15/279,798

(22) Filed: Sep. 29, 2016

Related U.S. Application Data
(60) Provisional application No. 62/234,162, filed on Sep. 29, 2015.

(51) Int. Cl. C09J 7/02; B32B 37/26; B32B 29/00; B32B 37/12; B32B 7/12; B32B 5/18

(52) U.S. Cl. CPC C09J 7/0207; B32B 7/12; B32B 5/18; B32B 29/00; B32B 37/12; B32B 37/26; C09J 7/0225; B32B 2307/102; B32B 2605/08; B32B 2037/1246; B32B 2037/268; B32B 2367/00; C09J 2201/606; C09J 2201/61; C09J 2467/005; C09J 2405/008; B60R 13/0838

(57) ABSTRACT

The teachings herein include an article having an acoustic absorption material: a pressure sensitive adhesive material attached to the acoustic absorption material: and a release liner located on an opposing side of the pressure sensitive adhesive material The article is adapted to be molded into a desired shape. The molded article may then be adhered to a desired substrate upon removal of the release liner. The teachings herein also contemplate methods of forming the article and installing the article.

### TECHNICAL FIELD

The present teachings pertain generally to adhesive materials, and more particularly to a moldable composite including a pressure sensitive adhesive material and a release liner adapted to be molded and to withstand elevated temperatures.

### BACKGROUND

Pressure sensitive adhesive (PSA) materials can be used to adhere materials to other materials, articles, substrates or surfaces. For example, pressure sensitive adhesives may be used to attach acoustic absorption materials to a substrate, or to keep the acoustic absorption materials in a desired location. Acoustic absorption materials are particularly useful, for example, in automotive applications, or in another instance where a reduction of noise may be desired.

PSA materials are often generally two dimensional and attached to a flat part or article. However, the desired substrate may not be a flat surface; instead, it may be curved, or have one or more angular components upon which the article is to be attached. The flat part or article with a PSA attached thereto can be forcibly bent or contoured, by hand for example, during the installation process (e.g., to fit within a desired area and/or attach to the desired substrate), but this is done at the risk of creating areas of high stress in the PSA and/or part or article, which may cause the PSA to delaminate from the substrate or cause the part or article to lift from the area to which it is intended to be adhered. In the alternative, a plurality of flat, two dimensional parts with PSA attached thereto may be layered together in a stack to form a desired shape of material and PSA. However, these must be fastened separately in specific areas of the substrate contour.

Acoustic absorption materials may be molded or thermoformed into three-dimensional shapes to match the shape of the area or substrate to which they will be secured. However, attachment of these acoustic absorption materials is often difficult due to the shape of the acoustic absorption material, the shape of the substrate to which the acoustic absorption material is to be attached, or both. Other known PSA materials and release liners, such as those disclosed in U.S. Pat. No. 6,426,130, can be shaped; however, they are not able to withstand high temperatures during the manufacturing process of the acoustic absorption material, so additional processing steps in forming the acoustic absorption material and adhering the acoustic absorption material to a substrate are necessary.

Attachment of acoustic absorption materials to a substrate traditionally has been possible through mechanical fastening mechanisms and/or mechanical clips. However, attachment often requires mechanical fastening mechanisms that are specifically designed for that particular substrate and/or acoustic absorption material. As such, the use of these mechanisms may complicate the design process, the installation process, or both. Mechanical fasteners may also provide additional weight to the assembly, which may be undesirable.

It is therefore desired to address or ameliorate one or more shortcomings or disadvantages associated with existing methods of attachment, such as for attaching an acoustic absorption material to a substrate, where either the acoustic absorption material, the substrate, or both, have a contoured surface, or to at least provide a useful alternative thereto.

### SUMMARY

The present teachings may provide improvements to pressure sensitive adhesive materials so that the PSA material and release liner can be efficiently shaped or molded to fit or molded with an article, such as an acoustic absorption material, to be attached to a substrate. The present teachings may also allow for the PSA materials, release liners, carrier layers, or a combination thereof, to exhibit minimal shrinkage during periods of exposure to high temperatures.

It is contemplated that the present teachings may include any or all of the following elements, or any combination thereof. The present teachings include a moldable composite that includes a pressure sensitive adhesive material and a release liner, which are capable of being shaped or molded into a desired shape, such as a shape that generally matches the contours of a substrate to which the pressure sensitive adhesive material and moldable composite is being applied. The moldable composite may include an acoustic absorption material; a pressure sensitive adhesive material attached to the acoustic absorption material; and a release liner located on an opposing side of the pressure sensitive adhesive material. The moldable composite may be adapted to begat least partially molded or shaped into a desired shape or to have one or more desired contours or a desired topography. One or more of the elements of the moldable composite (e.g., PSA material, release liner, acoustic absorption material, facing layer, carrier layer, or any combination thereof) may be adapted to exhibit minimal shrinkage (e.g., about 10% or less, or about 5% or less) when the element is exposed to elevated temperatures (e.g., up to about 250° C.) during assembly and/or shaping of the moldable composite. The one or more elements may be adapted to withstand exposure to these elevated temperatures for up to about 120 seconds when the moldable composite is shaped.

It is contemplated that the acoustic absorption material may be a porous bulk absorber. The acoustic absorption material may be formed from fibrous materials. Formation of the acoustic absorption material may be by vertical lapping, cross lapping, air laying, needle punching or a combination thereof. The acoustic absorption material may include a moldable foam or activatable material. The acoustic absorption material may include a cellulosic shoddy-based product. The acoustic absorption material may include two or more acoustic absorption layers, which may enhance the acoustic absorption properties of the material The moldable composite may include a facing layer or air flow resistive layer on a side of the acoustic absorption material opposite the pressure sensitive adhesive material,

The pressure sensitive adhesive material may be applied to the acoustic absorption material or to the release liner as a film. The pressure sensitive adhesive material may include a reinforcing element, such as a high temperature reinforcing scrim or a mesh, embedded in the pressure sensitive adhesive material. The pressure sensitive adhesive may be supported by a carrier layer. The carrier layer may be secured to the acoustic absorption material (e.g., so the carrier layer is located between the acoustic absorption material and the pressure sensitive adhesive material). The carrier layer may be secured to the acoustic absorption material by a hot melt adhesive. The release liner of the present teachings may be a polyester-based release liner. The release liner may have a thickness of about 0.02 mm to about 0.15 mm. The release liner may have a release value of about 0.01 N/25 mm width OF more, about 0.05 N/25 mm width or more, or about 0.07 N/25 mm width or more. The release liner may have a release value of about 0.5 N/25 mm width or less, about 0.35 N/25 mm width or less, or about 0.25 N/25 mm width or less. For example, the release liner may have a release value of about 0.08 N/25 mm width to about 0.20 N/25 mm width. The release value may be measured using a T-peel test per ASTM D1876.

The present teachings also include a method of forming the moldable composite. The method includes supplying an acoustic absorption material; securing a pressure sensitive adhesive material having a release liner to one side of the acoustic absorption material; and shaping the acoustic absorption material and pressure sensitive adhesive having a release liner. The release liner may be a material capable of withstanding exposure to exposed temperatures, such as a polyester based high temperature release liner. The shaping step may include exposing the materials to a high temperature, such as a temperature of about 150 C. or higher. The shaping step may be performed during a high temperature lamination process, a molding process, a thermoforming process, or combination thereof. The moldable composite may be exposed to temperatures up to about 250° C.. The moldable composite may be exposed to elevated temperatures (e.g., about 250° C.) for up to about 120 seconds The method may further comprise removing the release liner and adhering the moldable composite to a desired substrate. The moldable composite may be attached to the desired substrate without the use of mechanical fasteners.

### Description of the Drawings

FIG. 1 illustrates a moldable composite having a pressure sensitive adhesive film layer and an acoustic absorption material in accordance with the present teachings.

FIG. 2 illustrates a moldable composite having a pressure sensitive adhesive film layer, an acoustic absorption material layer, and a carver layer in accordance with the present teachings.

FIG. 3 illustrates a molded or shaped composite having a pressure sensitive adhesive film layer and an acoustic absorption material in accordance with the present teachings.

### DETAILED DESCRIPTION

The present teachings meet one or more of the above needs by, the improved elements and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use, Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes, Other combinations are also possible as will be gleaned from the claims, which are also hereby incorporated by reference into this written description.

The teachings herein make advantageous use of pressure sensitive adhesive (PSA) materials, especially PSA materials and release liners that are able to be shaped, molded, contoured, or a combination thereof. Pressure sensitive adhesives are useful in a wide variety of applications for adhesion of one substrate to another substrate or article. The PSA material as, disclosed herein may be particularly useful for adhering acoustic absorption materials to a wall, article, surfaces defining a cavity (e.g., in a vehicle) or other substrate in an area where acoustic absorption and/or noise reduction is desired.

Acoustic absorption materials have an array of applications, such as, but not limited to, automotive applications, generator set engine compartments, commercial vehicle engine, in-cab areas, architectural applications, and even heating, ventilating and air conditioning (HVAC) applications. Acoustic absorption materials may be suitable for use as sound attenuation materials in vehicles, attenuating sound originating from outside a cabin of a motor vehicle and propagating toward the inside of the cabin. Acoustic absorption materials may be used for machinery and equipment insulation, motor vehicle insulation, domestic appliance insulation, dishwashers, acoustic pin boards, and commercial wall and ceiling panels or tiles. Acoustic absorption materials may be used in the engine cavity of a vehicle, on the inner and outer dash panels and under the carpeting in the cabin, for example, Acoustic absorption materials may be used inside cabs to provide acoustic absorption. Acoustic absorption materials may be used as interior decorative trim (in which case, it, may be necessary to face the acoustic sheet, such as with some form of decorative fabric or other covering). More than one acoustic absorption material may be used in combination with each other.

To employ such acoustic absorption materials, it may be necessary to attach the materials to a desired substrate and/or secure the acoustic absorption material in a desired location. The present teachings may act as an assembly aid and/or a permanent fastening mechanism for attaching and securing these acoustic absorption materials to their intended substrate or location.

The present teachings herein are generally directed to a moldable composite. This moldable composite may include a pressure sensitive adhesive (PSA) material and a release liner, which may, allow for peel-and-stick functionality (e.g., of an acoustic absorption material to a substrate). The moldable composite may include one or more acoustic absorption layers, which make up the acoustic absorption material. The PSA material may be attached to the acoustic absorption material so that the acoustic absorption material may be, attached to a substrate (e.g., by removing the release liner and adhering the acoustic absorption material to the substrate). The moldable composite may include one or more facing layers (e.g., on the opposite side of the acoustic absorption material, from the PSA material), which, may be positioned, on the moldable composite to face the source of the noise and/or to provide additional sound absorption characteristics, for example. The moldable composite may be subjected to one or more shaping techniques so that the moldable composite can be formed into a desired shape (e.g., in a three-dimensional shape or non-planar shape), such as generally match the topography or one or more contours or angled portions of the substrate to which the moldable composite is to be installed.

In general, materials used for sound absorption (e.g., composite absorption materials, nonwoven materials, woven materials foamable or other activatable materials, the like, or combination thereof) must exhibit air permeability properties. Critical characteristics include air flow resistance (resistance to air flow through the material), tortuosity (the path length of sound wave within the material), and porosity (void to volume ratio). With fibrous materials, air flow resistance is an overwhelmingly critical factor controlling sound absorption.

Air flow resistance is measured for a particular material at a particular thickness. The air flow resistance is normalized by dividing the air flow resistance (in Rayls) by the thickness (in meters) to derive the air flow resistivity measured in Rayls/m. ASTM standard C522-87 and ISO standard 9053 refer to the methods for determination of air flow resistance, for acoustic absorption materials. Within the context of the described embodiments, air flow resistance, measured in mks Rayls, will be used to specify the air flow resistance; however other methods and units of measurement are equally valid. Within, the context of the described embodiments, air flow resistance and air flow resistivity can be assumed to also represent the specific air flow resistance, and specific air flow resistivity, respectively.

Composite products, such as acoustic absorption materials, may be formed, at least in part, from porous limp sheets with relatively high air flow resistances, porous bulk absorbers or spacer materials having air flow resistances smaller than the limp sheets, or both. Methods for producing such composite products include those set out in co-owned International Application No. PCT/AU2005/000239 entitled “Thermoformable Acoustic Product” (published as WO/2005/081226), the contents of which are hereby incorporated by reference herein,

Acoustic absorption materials may be formed of many different materials and methods, depending on the application and the desired air flow resistance. The acoustic absorption material may include one or more acoustic absorption layers. Acoustic absorption materials (or one or more of the layers making up the acoustic absorption material) may include fibrous materials, vertically lapped materials, cross-lapped materials, air laid materials, needle punched materials, shoddy based products (e.g., cellulosic shoddy based products), moldable foams, the like, or a combination thereof. An acoustic absorption material, or at least one layer making up the acoustic absorption material, may be formed to have a thickness and density selected according to the required physical and air permeability properties desired of the finished acoustic composite layer (and/or the acoustic composite as a whole). The thickness of the acoustic absorption material (or at least one layer of the acoustic absorption material) may be dependent on the application, location of installation, method of formation, shape, fibers used (and the lofting of the acoustic composite layer), among other factors. The acoustic absorption material may have an average thickness of about 0.1 mm or more, about 0.5 mm or more, or about 1 mm or more. The acoustic absorption material may have an average thickness of about 300 mm or less, about 200 mm or less, or about 150 mm or less. For example, the acoustic absorption material may have an average thickness of about 1 mm to about 150 mm. The finished moldable composite, after shaping into the desired shape, may have a varying thickness across the profile of the moldable composite. The variance in thickness may be due to the shaping of the moldable composite into a particular shape (e.g., a shape that generally matches the shape or contours or angled portions of the substrate to which the moldable, composite will be affixed).

The density of the acoustic absorption material may depend, in part, on the specific gravity of any additives incorporated into the material or one or more layers of the acoustic absorption material (such as nonwoven material), and/or the proportion of the final material that the additives constitute, Bulk density generally is a function of the specific gravity of the fibers and the porosity of the material produced from the fibers, which can be considered to represent the packing density of the fibers. A low density acoustic absorption material may be designed to have a low density with a finished thickness of about 1.5 mm or more, about 4 mm or more, about 5 mm or more, about 6 mm or more, or about 8 mm or more. The finished thickness may be about 350 mm or less, about 250 mm or less, about 150 mm or less, about 75 mm or less, or about 50 mm or less. After shaping (e.g., thermoforming), the acoustic absorption material may have varying thicknesses (e.g., nonuniform) throughout the material. The acoustic composite material may be formed as a relatively thick, low density nonwoven, with a bulk density of 10 kg/m³ or more, about 15 kg/m³ or more, or about 20 kg/m³ or more. The thick, low density nonwoven may, have a bulk density of about 200 kg/m³ or less, about 100 kg/m³ or less, or about 60 kg/m³ or less. The acoustic composite material (e.g., serving as one or more acoustic composite layers) thus formed may have an air flow resistivity of about 400 Rayls/m or more, about 800 Rayls/m or more, or about 100 Rayls/m or more. The acoustic composite material may have an air flow resistivity of about 200,000 Rayls/m or less, about 150,000 Rayls/m or less, or about 100,000 Rayls/m or less. Low density acoustic composite materials may even have an air flow resistivity of up to about 275,000 Rayls/m.

Fibers that may form the acoustic absorption material (and/or a facing layer) may be natural or synthetic fibers. Suitable natural fibers may include cotton, jute, wool, cellulose and ceramic fibers. Suitable synthetic fibers may include polyester, polypropylene, polyethylene, Nylon, aramid, imide, acrylate fibers, or combination thereof. The acoustic composite layer material may comprise polyester fibers, such as polyethylene terephthalate (PET), and co-polyester/polyester (e.g., CoPET/PET) adhesive bi-component fibers. The fibers may be 100% virgin fibers, or may contain fibers regenerated from postconsumer waste (for example, up to about 100% fibers regenerated from postconsumer waste). It is contemplated that glass fibers may also be present within the fibrous material, which may provide additional structural properties and/or stiffness to the acoustic absorption material.

The material fibers that may make up the acoustic absorption material may have a linear mass density from about 0.5 to about 25 denier, preferably about 1 to about 6 denier, more preferably about 1 to about 4 denier. The fibers, may have a staple length of about 1.5 millimeters or greater, or even up to about 70 millimeters or greater (e.g., for carded fibrous webs). For example, the length of the fibers may be between about 30 millimeters and about 65 millimeters, with an average or common length of about 50 or 51 millimeters staple length, or any length typical of those used in fiber carding processes. Short fibers may be used in some other nonwoven processes, such as the formation of air laid fibrous webs. For example, some or all of the fibers may be a powder-like consistency (e.g., with a fiber length of about 2 millimeters to about 3 millimeters). Fibers of differing lengths may be combined to form the acoustic composite layer. The fiber length may vary depending on the application, the acoustic properties desired, dimensions and/or properties of the acoustic material (e.g., density, porosity, desired air flow resistance, thickness, size, shape, and the like of the acoustic layer), desired structural properties, stiffness, OF any combination thereof. More effective packing of the fibers (such as by using short fibers) may allow pore size to be more readily controlled in order to achieve desirable acoustic characteristics.

The acoustic absorption material may include a plurality of bi-component fibers. The bi-component fibers may include a core material and a sheath material around the core material. The sheath material may have a lower melting point than the core material. The web of fibrous material may be formed, at least in part, by heating the material to a temperature to, soften the sheath material of at least some of the bi-component fibers. The temperature to which the fibrous web is heated to soften the sheath material of the bi-component may depend upon the physical properties of the sheath material. For a polyethylene sheath, the temperature may be about 140 degrees C to about 160 degrees C. For a polypropylene sheath, the temperature may be higher (for example, about 180 degrees C). The bi-component fibers may be formed of short lengths chopped from extruded bi-component fibers. The bi-component fibers may have a sheath-to-core ratio (in cross-sectional area) of about 25% to about 35%.

The fibers forming the acoustic absorption material may be formed into a nonwoven web using nonwoven processes including, for example, blending fibers (e.g., blending bi-component fibers, conventional staple fibers, or combination thereof), carding, lapping, air laying, mechanical formation, or combination thereof. The fibers of the acoustic absorption material may be opened and blended using conventional processes. The fibers may be blended within the structure of the fibrous web. A carded web may be cross-lapped, vertically lapped, or rotary lapped, to form a voluminous nonwoven web. The carded web may be vertically lapped according to processes such as “Struto” or “V-Lap”, for example. This construction provides a web with relative high structural integrity in the direction of the, thickness of the composite sound absorber, thereby minimizing the probability of the web falling apart during application, or in use. Carding and lapping processes create a nonwoven fiber layer that has good compression resistance through the vertical cross-section and enables the production of a lower mass acoustic treatment, especially with lofting to a higher thickness without adding significant amounts of fiber to the matrix. Such an arrangement also provides the ability to achieve a low density web with a relatively low bulk density. A web may also or instead be formed by air laying, needle punching, mechanically forming the web, or combination thereof. The web may then be thermally bonded, air bonded, mechanically consolidated, the like, or combination thereof, to form a cohesive nonwoven insulation material.

The fibers of the acoustic absorption material may be blended or otherwise combined with suitable additives such as other forms of recycled waste, virgin (non-recycled) materials, binders, fillers (e.g., mineral fillers), adhesives, powders, thermoset resins, coloring agents, flame retardants, longer staple fibers, etc., without limitation.

Acoustic absorption materials are not limited, however, to fibrous materials. Foams or activatable materials, such as a foamable material, may exhibit sound absorption characteristics. Foams or other activatable materials may also be shapeable and/or moldable to a desired shape or to have one or more desired contours or angles (e.g., to generally match the contours of the substrate to which the moldable composite is to be attached). Moldable polyurethane, melamine, elastomeric, nylon/aramid, and olefin foams, among other types, are potential acoustic absorption materials than can utilize a moldable PSA system. Foams or other activatable materials can also be used in combination with one or more fibrous layers or facings.

As noted, acoustic absorption materials may be formed from multiple acoustic absorption layers. These layers may have different air flow resistances (e.g., to create an impedance mismatch between the layers). The layers may have the same, or generally the same, air flow resistances. The layers may be constructed of different materials or different fiber lengths, which may alter the air flow resistive properties of the layers. The layers may be constructed of the same, or generally the same, materials and/or fiber lengths. The layers may then be attached to each other to form an acoustic absorption material for the moldable composite, such as by a laminating process.

On one side, typically the side facing the source of the noise, the acoustic absorption material may include a facing layer or other air flow resistive layer. Additional sound absorption may also be provided by the facing layer or layer of other material on the acoustic absorption material (e.g., by laminating or otherwise attaching or adhering to a surface of the acoustic, absorption material). The facing layer may have the same or similar air, flow resistance than the acoustic absorption material. Preferably, the facing layer has a different air flow resistance than the, air flow resistance of the acoustic absorption material. The facing layer or other layer within the acoustic absorption material may include air flow resistive fabrics or films that may provide an air flow resistivity of about 100,000 Rayls/m or higher, about 275,000 Rayls/m or higher, about 1,000,000 Rayls/m or higher, or even about 2,000,000 Rayls/m or higher. For example, a facing layer may have a thickness of about 0.0005 m and may have a specific air flow resistance of about 1000 Rayls. Therefore, the air flow resistivity would be about 2,000,000 Rayls/m. In another example, a fabric or film facing layer may have a thickness of about 0.0005 inches, or about 0.013 mm, with a specific air flow resistance of about 1000 Rayls. Therefore, the air flow resistivity would be about 7,700,000 Rayls/m. Types of facing layers may include, but are not limited to, films, foils, woven or nonwoven scrims, and the like. The facing layer may have openings to allow sound waves and/or air to pass through to the acoustic absorption layer below. The types of openings may be present in the material itself (e.g., a woven or nonwoven scrim) or the openings may be added (e.g., via perforation of a film or foil). If an adhesive or other method of attachment is used to secure the facing layer to the acoustic absorption material, it may be preferable that the adhesive or other method of attachment does not block the openings in the material (e.g., so that air and/or sound waves can pass through the openings and into the acoustic absorption material).

Acoustic absorption materials, such as porous bulk absorbers or foam materials, may be designed to be moldable into three-dimensional shapes to fit into particular spaces and/or to provide acoustic absorption to a non-planar substrate. The acoustic absorption materials may undergo one or more processes for attaching the layers to each other (e.g., lamination) and/or one or more processes for shaping the materials (e.g., molding and/or thermoforming). The acoustic absorption material may be a thermoformable material. A thermoformable material may be formed with a broad range of densities and thicknesses. The thermoformable material may contain a thermoplastic and/or a thermoset binder. During shaping of the acoustic absorption material, the thermoformable material may be heated and thermoformed into a specifically shaped thermoformed product, such as to generally match the shape of the area and/or topography or contours of the surface to which the moldable composite is to be secured. With the present teachings, it is contemplated that the processes for attaching the layers to each other and shaping the materials include attaching or applying a PSA material having a release liner to the acoustic absorption material and shaping the entire moldable composite (e.g., with the PSA material and release liner attached to the acoustic absorption material).

The acoustic absorption material may be of a uniform thickness before and/or after molding, thermoforming, or otherwise shaping. The acoustic absorption material may be of a varied thickness before and/or after molding, thermoforming, or otherwise shaping. After molding or otherwise shaping, it is contemplated that a portion of the acoustic absorption material may generally match the surface topography or shape of the surface to which the acoustic absorption material is to be adhered, whereas other portions do not. For example, a lower surface of the acoustic absorption material and/or the pressure sensitive, adhesive material (with or without a release liner) may be shaped to match the shape of the surface to which it is to be adhered, while the outer surface (or surface directed away from the substrate) of the acoustic absorption material and/or a facing material may be generally flat or smooth, or of a different texture, shape, or profile than the lower surface.

The present teachings include the use of a pressure sensitive adhesive material for securing an article, such as an acoustic absorption material, to a substrate. The PSA material as described herein may function to provide a fastening system for parts (e.g., an acoustic absorption material that is capable of being molded or otherwise shaped). The PSA material may allow for these parts to be attached to a desired substrate without the need for mechanical attachments or fasteners, such as clips, screws, bolts, pins, and the like. The PSA material, may allow for the parts to be attached to a desired substrate without any additional methods of attachment (i.e., the PSA provides sufficient adhesion to the substrate and supports the acoustic absorption material thereon).

The PSA material may be a high temperature resistant polymer system. The PSA material preferably is able to withstand high temperatures, such as the temperatures reached in lamination, molding, thermoforming processes, or a combination thereof. In these processes, the PSA material may be exposed to temperatures up to about 250° C., for example. The exposure to high temperatures (e.g., about 250° C. or less) may be for as long as about 120 seconds. It is contemplated that the PSA material may be exposed to and be able to withstand temperatures lower than 250° C. (e.g., about 200° C. or lower) for longer periods of time than 120 seconds. The PSA material may be an acrylic resin, such as one that is curable under ultraviolet (UV) light, such as AcResin type A 260 UV available from BASF of Germany. Some suitable acrylic resins are described in U.S. Pat. Nos. 5,128,386 and 5,741,829. Other types of PSA materials may be employed that can be cured under different conditions, whether as a result of irradiation or another curing method. For example, the PSA material may comprise a hot-melt synthetic rubber-based adhesive or a UV-curing synthetic rubber-based adhesive. The PSA material may include a non-UV acrylic resin, such as solvent-borne or water-emulsion. A scrim, mesh, or other supportive material may be embedded within the PSA material, which may provide reinforcement to the PSA material. For example, there may be a bi-directional reinforcing scrim embedded in the PSA material.

In an unsupported pressure sensitive adhesive system, the PSA material may be applied or coated directly onto a release liner. The PSA material may then be attached to the acoustic absorption material (e.g., so the PSA material is sandwiched between the acoustic absorption material and the release liner), such as during a lamination process. Alternatively, the pressure sensitive adhesive system may be supported by a carrier, such as a film carrier layer. The carrier layer may be formed, for example, of any material capable of being molded or shaped during the process of shaping the acoustic absorption material. The PSA material may be applied directly to the release liner and then attached to the carrier layer, such as by nip pinching the pressure sensitive, adhesive material and release liner to the carrier layer, Instead, the PSA material may be applied or coated directly onto the carrier layer and the release liner may be separately attached, such as by nip pinching the release liner to the PSA material and the carrier layer. The carrier layer may then be attached, to the acoustic absorption material, such as by bonding the opposing side of the carrier layer (opposite the side carrying the PSA material) to the acoustic absorption material. The carrier layer may be bonded to the acoustic absorption material by one or more adhesive materials. For example, the carrier layer may be bonded to the acoustic absorption material with a hot melt adhesive during a lamination process. It is also contemplated that the PSA material may be coated directly onto the acoustic absorption material. The release liner may then be attached to the opposing side of the PSA material (e.g., by a method such as nip pinching).

The pressure sensitive adhesive material may be applied to a release liner or a carrier layer, in a thickness of, about 10 microns or more, about 20 microns or more, or about 30 microns or more. The pressure sensitive adhesive material may be applied to the release liner or carrier layer in a thickness of about 150 microns or less, about 100 microns or less, or about 75 microns or less. The pressure sensitive adhesive material may be heated (e.g., to about 140° C.) to apply the material to the substrate, Depending on the temperature-related behavior of the chosen material of the release liner and/or carrier layer, the application temperature of the pressure sensitive adhesive material may be varied.

The pressure sensitive adhesive may be applied to the release liner or carrier layer in the form of a film. The pressure sensitive adhesive may be applied from a roll and laminated to the acoustic absorption material. The PSA material may provide full coverage of the acoustic absorption material, release liner, carrier layer, or a combination thereof. The PSA material may provide partial coverage of the acoustic absorption material, release liner, carrier layer, or a combination thereof. The PSA material may be applied in the form of strips or another intermittent pattern (e.g., coating with a plurality of dots, diamond/polygonal shapes, stripes, checkered pattern, grid pattern, the like, or combination thereof). The intermittent pattern may allow for gaps between segments or strips of the PSA material, which may achieve the coating weight desired for a particular application while saving a large percentage of the PSA resin by coating only some portions of the total area of the release liner, carrier layer, acoustic absorption material, or a combination thereof. The PSA material may be applied by hot-melt coating with a slot die, for example. The PSA material may be coated using a roller (e.g., a patterned roller) or a series of solenoid activated narrow slot coating heads, for example.

The PSA material may be applied to about 100% of the release liner or carrier layer (or a side of the acoustic absorption material). Depending on the size and spacing of the applied portions of the PSA material, the percentage of the coated area of the release liner or carrier layer may be varied. The applied area of the PSA material can vary between about 10% and about 100% of the area of the release liner or carrier layer (e.g., about 30% to about 40%). In some embodiments, the PSA material may be applied in strips, and the spacing of the strips may vary depending on the requirement of the end user or the shape the end moldable composite will be molded into. One or more gaps between PSA material segments or uncoated areas may assist in removal of the release liner (e.g., by providing a user or installer with additional space to grasp and pull the release liner away from the PSA material).

The moldable composite preferably includes a release liner. The release liner may serve to protect the pressure sensitive adhesive material and/or support the PSA material prior to installation of the moldable composite to a substrate. The release liner may serve to prevent sticking or attachment of the moldable composite to a surface or substrate until installation is desired, which may allow the moldable composites to be shipped or otherwise transported prior to installation. The release, liner may be, removed during installation of the moldable composite to provide a peel-and-stick functionality to the moldable composite.

Release liners may be selected to have a specific tear strength, flexibility, release value, temperature resistance, or any combination thereof. The release liner may be formed to have relatively high tear strength so it can be removed in one piece. The release liner may have a thickness that is about 0.005 mm or more, about 0.01 mm or more, or about 0.02 mm or more. The release liner may have, a thickness of about 0.3 mm or less, about 0.2 mm or less, or about 0.15 mm or less. The release liner may be a polyester-based material (e.g., polyester, modified polyester, co-polyester, or combination thereof). The release liner may be based on polyethylene terephthalate (PET) or other high temperature moldable thermoplastic film technology. The polyester-based material may be able to withstand elevated temperatures (e.g., up to about 250° C.). The polyester-based material may be moldable, and may be shaped during the molding or shaping process of the acoustic absorption material. For example, the PSA material and release liner may be attached to the acoustic absorption material via a lamination process and then the moldable composite may be shaped to have a desired shape or contour or topography by one or more molding and/or thermoforming processes.

The release liner is preferably an easy-release liner. Therefore, It may be desirable to achieve a release value between the PSA material and the release liner of about 0.01 N/25 mm width or more, about 0.05 N/25 mm width or more, or about 0.07 N/25 mm width or more. The release liner may have a release value of about 0.5 N/25 mm width or less, about 0.35 N/25 mm width or less, or about 0.25 N/25 mm width or less. For example, the release liner may have a release value of about 0.08 N/8 mm width to about 0.20 N/25 mm width. The release liner may have a coating on one or both sides that assists to achieve a specific release value on the side on which the PSA material is coated. The release liner may be coated on one or both sides with silicone release technology that is also able to withstand high temperatures (e.g., up to about 250° C.). A release liner coated with silicone release technology may have a release value of less than about 0.20 N/25 mm width, and may have an easy start to the removal of the liner.

As mentioned, in a supported PSA system, the pressure sensitive adhesive may be supported by a carrier layer. The PSA may be applied directly to the carrier layer. Instead, the PSA may be directly applied to the release liner and then attached to the carrier layer (e.g., by nip pinching). The carrier layer is preferably a material capable of being exposed to high temperatures, such as a material based on PET or other higher temperature moldable thermoplastic film technology. A film carrier may be beneficial to provide support to the PSA material, particularly during removal of the release liner. For example, narrow strips of PSA material may lift off of porous articles during removal of the release liner. The carrier layer may help to provide additional area for upon which the PSA is secured.

The present teachings also include a method of assembling and using the moldable composite. In an exemplary method, the PSA material may be applied to the release liner. The PSA material and release liner may then be laminated or otherwise attached to an acoustic absorption material, where the PSA material is sandwiched between the acoustic absorption material and the release liner. During the same lamination step, or a separate step, a facing layer may be adhered to the acoustic absorption material (e.g., on the side of the acoustic absorption material opposite the PSA material). The acoustic absorption material, PSA material, and release liner (and optionally a facing layer), making up the moldable composite, may then be shaped, such as by molding and/or thermoforming, into a desired shape, such as to generally match the contours of the surface or surface topography of the substrate to which the acoustic absorption material is to be attached. Prior to installation of the finished moldable composite, the release liner may be removed from the PSA material, and the moldable composite can then be positioned in the desired area of installation on the surface of a substrate.

In another exemplary method, the present teachings may include using a supported PSA material. Therefore, the PSA material may be applied or coated to a release liner, and a carrier layer may be attached, such as by nip pinching, to the exposed side of the PSA material. The PSA material may instead be applied or coated onto a carrier layer, and the release liner may be attached, such as by nip pinching, to the exposed side of the PSA material. The carrier layer may then be attached to the acoustic absorption material, such as during a lamination process. The carrier layer may be bonded to the acoustic absorption material using an adhesive, such as a hot melt adhesive. An optional facing, layer may also be attached to the acoustic absorption material (e.g., the side of the acoustic absorption material opposite the PSA material) during the same lamination step or in a separate step. The acoustic absorption material, PSA material, carrier layer, release liner, and the optional facing layer making up the moldable composite may be shaped, such as by molding and/or thermoforming (e.g., to generally match the contours of the surface of the substrate to which the acoustic absorption material is to be attached).

During the shaping step of the exemplary methods above, the moldable composite may be exposed to temperatures up to about 250° C. An advantage of using high temperature materials for the PSA material, release liner, and optional carrier layer, is that these materials can be exposed to high temperatures and exhibit minimal shrinkage. This also allows the moldable composite (e.g., in its assembled form) to be laminated and/or shaped. The shaping step of the moldable composite (e.g., including the acoustic absorption material, PSA material and release liner) in a single step and/or at the same time may reduce processing steps required.

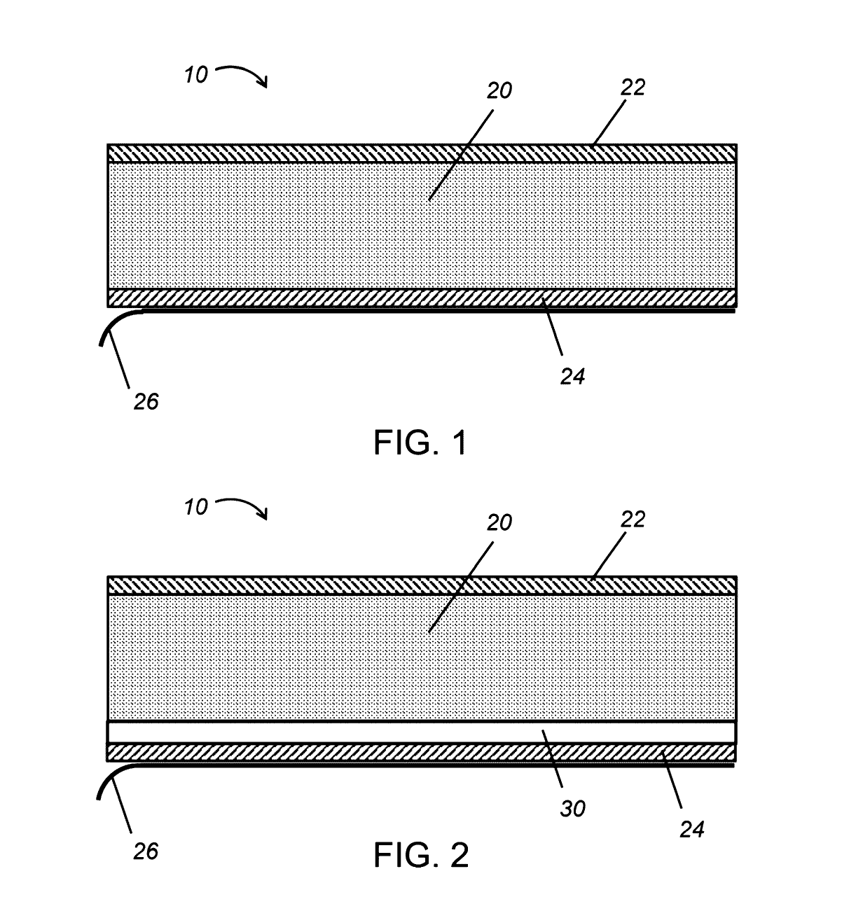

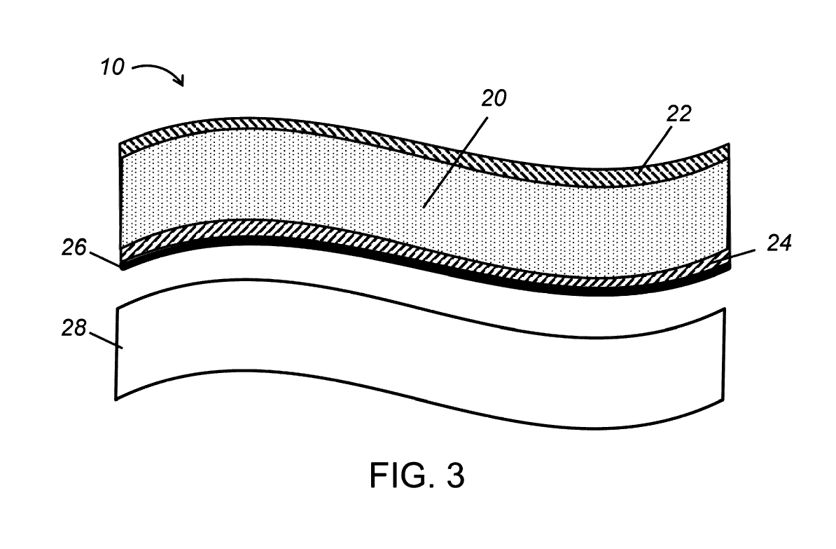

FIGS. 1 and 2 illustrate an exemplary moldable composite 10. The moldable composite 10 includes an acoustic absorption material 20, which may be a lofted porous bulk absorber or other acoustic absorption material, such as a material that is vertically lapped, cross-lapped, air laid, needle punched, short fiber laid, or a combination thereof. The moldable composite 10 may include a facing material 22, which may be laminated to the acoustic absorption material 20 and may face the source of the noise. This facing material 22 may provide protection for the acoustic absorption material 20 and/or may provide additional air flow resistive properties to the moldable composite 10. On an opposing side of the acoustic absorption material 20, a pressure sensitive adhesive material 24 is applied or secured. The PSA material 24 may be applied as a film. The PSA material 24 is preferably a high-temperature system able to withstand high temperatures, such as those of lamination and molding (e.g., up to about 250° C.). The PSA material is sandwiched between the acoustic absorption material 20 and a release liner 26. The release liner 26 may be removed upon installation of the moldable composite 10 to a substrate, which provides peel-and-stick functionality to the moldable composite 10. The release liner 26 is preferably a polyester-based high temperature easy release liner that is moldable and can withstand temperatures up to about 250° C., such as during the lamination and molding steps, during shaping, of the moldable composite to match the shape of the substrate to which it will be attached. As shown in FIG. 2, the moldable composite 10 may include a carrier layer 30 located between the PSA material 24 and the acoustic absorption material 20 to provide additional support to the PSA material 24, such as upon removal of the release liner 26.

FIG. 2 illustrates an exemplary moldable composite 10 that has been molded or otherwise shaped to match the shape or surface topography of the substrate 28 to which it is intended to be applied. The moldable composite 10 includes an acoustic absorption material 20. The moldable composite 10 includes an optional facing material 22 laminated or otherwise attached to the acoustic absorption material 20. When the moldable composite 10 is installed on the substrate 28, the facing material 22 faces away from the, substrate 28 (e.g., to face the source of the noise). This facing material 22 may provide protection for the acoustic absorption material 20 and/or may provide additional air flow resistive properties to the moldable composite 10. On the opposing side of the acoustic absorption material 20 is a pressure sensitive adhesive (PSA) material 24. The PSA material 24 is sandwiched between the acoustic absorption material 20 and a release liner 26. The release liner 26 may be removed upon installation of the moldable composite 10 to the substrate 28, which provides peel-and-stick functionality to the moldable composite 10.

While the pressure sensitive adhesive material as disclosed herein is discussed within the context of formation and/or use with an acoustic absorption material, it is contemplated that the pressure sensitive adhesive material may be employed in other applications as well for adhering an article to a substrate where either or both the article and the substrate are non-planar. Therefore, the PSA as disclosed herein is not limited to use with acoustic absorption materials.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably'from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of at “x′ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of to describe a combination shall include the elements, ingredients, components or steps identified, and such other elements ingredients, components or, steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a ingle integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1) An article comprising:
a. an acoustic absorption material;
b. a pressure sensitive adhesive material attached to the acoustic absorption material;
c. a release liner located on an opposing side of the pressure sensitive adhesive material;
wherein the article after assembly is adapted to be molded into a desired three-dimensional shape.

2) The article of claim 1, wherein the acoustic absorption material is porous bulk absorber.

3) The article of claim 1, wherein the acoustic absorption material is formed from fibrous materials by vertical lapping, cross lapping, air laying, needle punching or a combination thereof,

4) The article of claim 1, wherein the acoustic absorption material includes a moldable foam.

5) The article of claim 1, wherein the acoustic absorption material includes a cellulosic shoddy-based product.

6) The article of claim 1, wherein the pressure sensitive adhesive material is applied to the acoustic absorption material or the release liner as a film.

7) The article of claim 1, wherein the pressure sensitive adhesive material includes a high temperature reinforcing scrim embedded in the pressure sensitive adhesive material.

8) The article of claim 1, wherein the pressure sensitive adhesive material is supported by a carrier layer, and wherein the carrier layer is secured to the acoustic absorption material.

9) The article of claim 8, wherein the carrier layer is secured to the acoustic absorption material by a hot melt adhesive.

10) The article of claim 1, wherein the release liner is a polyester-based rebase liner.

11) The article of claim 1, wherein the release liner has a release value of about 0.08 N/25 mm width to about 0.20 N/25 mm width.

12) The article of claim 1, wherein one or more elements of the article are adapted to exhibit minimal shrinkage of about 5% or less when the article is exposed to temperatures up to about 250° C. when the article is molded.

13) The article of claim 12, wherein the article is adapted to exhibit minimal shrinkage for up to about 120 seconds when the article is molded.

14) The article of claim 1, wherein the article includes a facing layer or air flow resistive layer on a side of the acoustic absorption material opposite the pressure sensitive adhesive material.

15) The article of claim 1, wherein the acoustic absorption material includes two or acoustic absorption layers.

16) A method of forming an article, comprising:
a. supplying an acoustic absorption material;
b. securing a pressure sensitive adhesive material having a release liner to one side of the acoustic absorption material;
c. shaping the acoustic absorption material and pressure sensitive adhesive material having a release liner,
wherein the shaping step includes exposing the materials to a temperature of about 150° C. or higher.

17) The method of claim 16, wherein the shaping step is performed during a high temperature lamination and molding process where the article is exposed to temperatures up to about 250° C. for up to about 120 seconds.

18) The method of claim 16, wherein the method further comprises removing the release liner and adhering the article to a substrate.

19) The method of claim 18, wherein the article is attached to the substrate without mechanical fasteners.

20) The method of claim 16, wherein the release liner is a polyester-based high temperature release liner formed from modified polyester, co-polyester, or a polymeric blend with the dominant component being polyester.
